(19) United States
(12) Patent Application Publication
(10) Pub. No.: US 2017/0339672 A1
(43) Pub. Date: Nov. 23, 2017

(54) COMMUNICATION CONTROL APPARATUS, MOBILE COMMUNICATION SYSTEM, AND COMMUNICATION CONTROL METHOD

(71) Applicant: FUJITSU LIMITED, Kawasaki-shi (JP)

(72) Inventors: Yoshiharu TAJIMA, Yokohama (JP); Dai KIMURA, Yokohama (JP)

(21) Appl. No.: 15/473,215

(22) Filed: Mar. 29, 2017

(30) Foreign Application Priority Data
May 23, 2016 (JP) 2016-102745
Dec. 2, 2016 (JP) 2016-235091

(51) Int. Cl. H04W 72/04; H04W 74/08

(52) U.S. Cl. CPC H04W 72/04; H04W 74/0808

(57) ABSTRACT

A communication control apparatus includes: a throughput estimation unit configured to estimate a first throughput in case that a first mobile apparatus performs radio communication with a base station apparatus based on first information notified from the first mobile communication apparatus; a radio method selection unit configured to allocate to the first mobile station apparatus a first radio communication method performing radio communication with the base station apparatus by using a carrier sense method, when a first request throughput notified from the first mobile station apparatus and requested by the first mobile station apparatus is smaller than the estimated first throughput; and a notification processing unit configured to notify information relating to the allocated first radio communication method to the first mobile station apparatus.

### CROSS-REFERENCE TO RELATED APPLICATIONS

This application is based upon and claims the benefit of priority of the prior Japanese Patent Application No. 2016-102745, filed on May 23, 2016, and the prior Japanese Patent Application No. 2016-235091, filed on Dec. 2, 2016, the entire contents of which are incorporated herein by reference.

### FIELD

The embodiments discussed herein are related to a communication control apparatus, a mobile communication system, and a communication control method.

### BACKGROUND

Today, at a place where a lot of people using terminal apparatuses gather, a wireless access method such as wireless LAN (wireless Local Area Network; which may be referred to as “WLAN” hereinafter) is available in addition to a wireless access method such as LTE (Long Term Evolution). In this case, a user (or terminal apparatus) can preferentially use WLAN, for example. Switchover control from LTE to WLAN may be referred to as offload, for example. The switchover to WLAN can reduce the load of an LTE system and also, by the use of a WLAN channel having a lower price than an LTE channel, the user can reduce payment for a communication charge.

On the other hand, a Mobile Virtual Network Operator (MVNO) which provides a service using channels and functions of a Mobile Network Operator (MNO) is rapidly spreading. In the Mobile Virtual Network Operator, switchover from LTE to WLAN can reduce the use opportunity of an LTE channel which may lead to cost reduction.

A technique related to such mobile communication includes the following, for example. Namely, there is a radio terminal which performs communication using a communication unit having a higher throughput between a throughput associated with RSSI (Received Signal Strength Indicator) measured by an EV-DO (cdma 2000 n x evolution) communication unit and a throughput associated with RSSI measured by a WLAN communication unit.

According to the above technique, it is urged that, in a communicable configuration with a plurality of radio communication systems, it is possible to provide a radio terminal capable of improving a throughput.

Further, there is a terminal apparatus which derives a first value corresponding to the throughput of a communication system currently in use and a second value corresponding to the throughput of a communication system capable of being switched over, determines a threshold on the basis of the first and second values, to determine a change to another communication system on the basis of the determined threshold and the quality of a transmission channel.

It is urged, according to the above technique, that a switchover can be made to a radio communication system which is suitable in a transmission rate and stability, among a plurality of radio communication systems.

Further, there is an eNodeB which evaluates the metric of an on-time throughput, which is a measurement value of a data amount arriving at the reception side at a bitrate of a target bitrate or higher before reaching a delay threshold, to allocate an air interface to UE in a manner to maximize the metric.

It is urged that, according to the above technique, a method and a system for allocating to the UE one of RAT, among a plurality of RATs which are supported by a base station, can be provided.

### PRIOR ART DOCUMENTS

[Patent document 1] Japanese Laid-open Patent Publication No. 2009-10757.

[Patent document 2] Japanese Laid-open Patent Publication No. 2004-357213.

[Patent document 3] Japanese National Publication of International Patent Application No. 2015-520561.

However, the above throughput measurement is performed in a radio terminal either in the technique of using one of the EV-DO and the WLAN communication units having a higher throughput, or in the technique of using the threshold determined based on the values corresponding to the throughputs to switch to the other communication system. The switchover to the other communication system after the throughput measurement in the radio terminal has such a problem that a longer time is consumed for the switchover, as compared with the case of switching over without measuring the throughput.

Also, in the aforementioned technique of allocating the air interface to UE after evaluating the metric of the on-time throughput, the measurement of the on-time throughput is performed in the eNodeB. Therefore, there may be a case that, due to the measurement time of the on-time throughput, a long time is consumed to switch over the air interface.

Further, for example, there may be a case that, at the switchover from LTE to WLAN, the throughput of the WLAN after the switchover may be lower than the throughput of the LTE. Such a throughput reduction may cause the terminal apparatus to take a long time to acquire a content etc., or some user may set the terminal apparatus not to access the WLAN.

### SUMMARY

According to an aspect of the embodiments, a communication control apparatus includes: a throughput estimation unit configured to estimate a first throughput in case that a first mobile apparatus performs radio communication with a base station apparatus based on first information notified from the first mobile communication apparatus; a radio method selection unit configured to allocate to the first mobile station apparatus a first radio communication method performing radio communication with the base station apparatus by using a carrier sense method, when a first request throughput notified from the first mobile station apparatus and requested by the first mobile station apparatus is smaller than the estimated first throughput; and a notification processing unit configured to notify information relating to the allocated first radio communication method to the first mobile station apparatus.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a configuration example of a mobile communication system.

FIG. 2 illustrates a configuration example of a mobile communication system.

FIG. 3A illustrates a configuration example of a mobile station apparatus, and FIG. 3B illustrates a configuration example of an LTE base station apparatus.

FIG. 4A illustrates a configuration example of an access point, and FIG. 4B illustrates a configuration example of a control apparatus.

FIG. 5 is a sequence diagram illustrating an operation example.

FIG. 6 is a flowchart illustrating an operation example.

FIG. 7A illustrates an example of relationship between a reception level and a throughput, and FIG. 7B illustrates an example of relationship between a total throughput and the sum of request throughputs.

FIGS. 8A through 8D illustrate examples of relationship between a total throughput and the sum of request throughputs.

FIGS. 9A through 9D illustrate examples of relationship between a total throughput and the sum of request throughputs.

FIGS. 10A through 10D illustrate examples of relationship between a total throughput and the sum of request throughputs.

FIG. 11A illustrates a hardware configuration example of a mobile station apparatus, and FIG. 11B illustrates a hardware configuration example of an LTE base station apparatus or an access point.

FIG. 12 illustrates a hardware configuration example of a control apparatus.

FIG. 13 is a flowchart illustrating an operation example.

FIG. 14 illustrates an example of relationship between the number of users and a throughput.

FIG. 15 illustrates examples of evaluation values.

FIGS. 16A and 16B respectively illustrate configuration examples of a mobile communication system.

### DESCRIPTION OF EMBODIMENTS

Hereinafter, the embodiments of the present invention will be described. Here, in the embodiments, it is not intended to limit the techniques disclosed. Further, each embodiment may appropriately be combined as far as contradiction is not produced between processing contents.

Moreover, as to the terms used in the present specification and the technological contents described in the present specification, terms and technological contents described in specifications as standards related to communication in 3GPP, IEEE, etc. may appropriately be used.

### First Embodiment

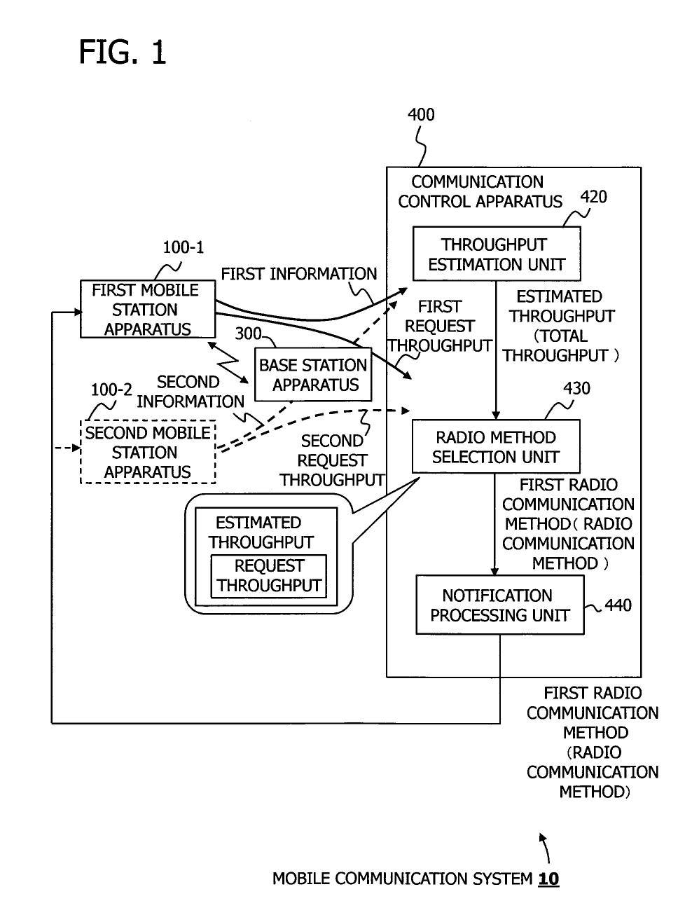

FIG. 1 illustrates a configuration example of a mobile communication system according to the present first embodiment. A mobile communication system 10 includes a first mobile station apparatus 100-1, a base station apparatus 300 and a communication control apparatus 400.

The first mobile station apparatus 100-1 are, for example, a radio communication apparatus such as a feature phone, a smart phone, a tablet terminal, a personal computer and a game apparatus. The first mobile station apparatus 100-1 can perform radio communication with the base station apparatus 300 using a first radio communication method, for example.

The communication control apparatus 400 includes a throughput estimation unit 420, a radio method selection unit 430 and a notification processing unit 440.

The throughput estimation unit 420 estimates a first throughput when the first mobile station apparatus 100-1 radio communicates with the base station apparatus 300 on the basis of first information reported from the first mobile station apparatus 100-1. The first information includes, for example, a signal reception level received from the base station apparatus 300 when the first mobile station apparatus 100-1 radio communicates with the base station apparatus 300.

The radio method selection unit 430 allocates a first radio communication method, by which radio communication with the base station apparatus 300 is performed using carrier sense, to the first mobile station apparatus 100-1, when a first request throughput, which is requested from the first mobile station apparatus 100-1 and reported from the first mobile station apparatus 100-1, is smaller than an estimated first throughput. Here, the first request throughput is a throughput which is requested from the first mobile station apparatus 100-1 at the execution of an application. Also, the first radio communication method is, for example, WLAN etc.

The notification processing unit 440 notifies the first mobile station apparatus 100-1 of information related to the allocated first radio communication method.

In this case, the base station apparatus 300 can radio communicate with the first mobile station apparatus 100-1 by the first radio communication method at the estimated first throughput. On the other hand, the first mobile station apparatus 100-1 requests a throughput of the first request throughput. Therefore, the first request throughput falls within the range of the first throughput at which the base station apparatus 300 can communicate. Thus, the first mobile station apparatus 100-1 can radio communicate with the base station apparatus 300 by the first radio communication method at the first request throughput.

Accordingly, the communication control apparatus 400 is configured to allocate the first radio communication method to the first mobile station apparatus 100-1 when the first request throughput is smaller than the first throughput. This enables the first mobile station apparatus 100-1 to perform radio communication by the first radio communication method at the first request throughput, so that can maintain a satisfactory connection state of the first mobile station apparatus 100-1 with the base station apparatus 300 by the first radio communication method.

Also, when using a second radio communication method by a scheduling method such as LTE different from the first radio communication method, the Mobile Virtual Network Operator may pay a higher usage charge than the first radio communication method. However, according to the present first embodiment, because the first radio communication method is allocated to the first mobile station apparatus 100-1, the Mobile Virtual Network Operator is not needed to pay the usage charge of the first radio communication method, which also enables cost reduction.

Further, according to the present first embodiment, the communication control apparatus 400 is configured to selected the first radio communication method to report to the first mobile station apparatus 100-1. Based on the reported information, the first mobile station apparatus 100-1 switches over to the first radio communication method so that may perform radio communication. Accordingly, as compared to a case when the first radio communication method is selected by the communication control apparatus 400 after the first mobile station apparatus 100-1 performs radio communication by the first radio communication method, radio communication by the first radio communication method is not performed before the selection according to the present first embodiment. Therefore, according to the present first embodiment, it is possible to reduce the switchover time of the radio communication method.

Further, as depicted with the dotted lines in FIG. 1, the communication control apparatus 400 may further receive second information and a second request throughput from the second mobile station apparatus 100-2. In this case, the throughput estimation unit 420 calculates the sum of throughputs of the first request throughput and the second request throughput (or a total throughput). If the sum of the first request throughput and the second request throughput is smaller than the total throughput, the radio method selection unit 430 allocates the first radio communication method to the second mobile station apparatus 100-2.

In this case also, the sum of the request throughputs falls within the range of the total throughput, and therefore, if the first radio communication method is allocated in such a case, the first and second mobile station apparatuses 100-1, 100-2 can radio communicate with the base station apparatus 300 at each throughput requested therefrom.

Thus, according to the present mobile communication system 10, a connection state with the mobile station apparatus can be satisfactorily maintained if the number of mobile station apparatuses increases.

### Second Embodiment

Next, a second embodiment will be described.

<Configuration Example of Mobile Communication System>

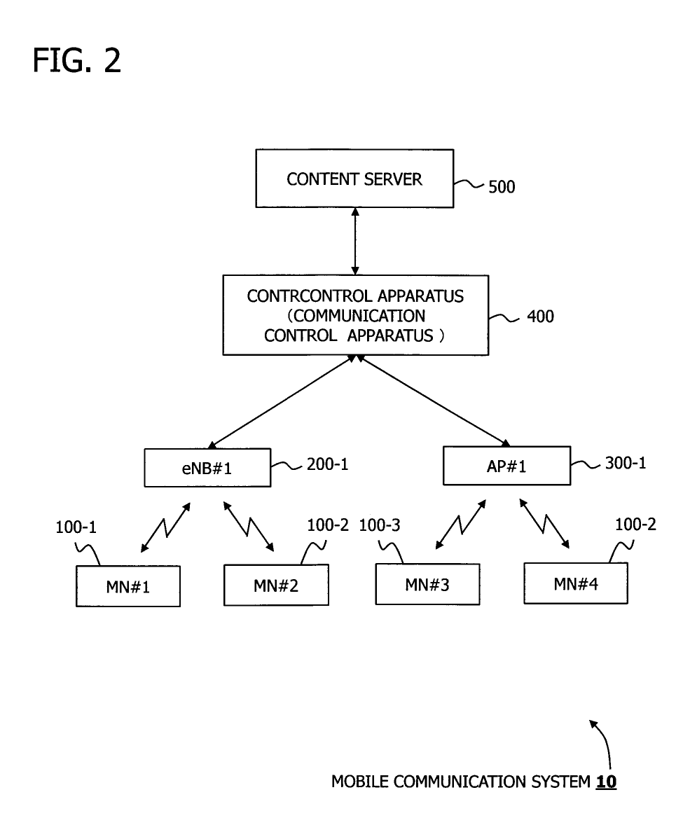

FIG. 2 illustrates a configuration example pf the mobile communication system 10 according to the present second embodiment. Here, as the mobile communication system 10 depicted in FIG. 2, a description is given by taking two radio communication methods, which are a first radio communication method by LTE and a second radio communication method by WLAN, as an example.

As examples of the first radio communication method, there are LTE-Advanced, W-CDMA (Wideband Code Division Multiple Access), 3G (3rd Generation Mobile Networks or 3rd Generation Wireless System) and 5G (5th Generation Mobile Networks or 5th Generation Wireless System), other than LTE. The first radio communication method is, for example, a method of scheduling in an LTE base station 200-1 to execute radio communication according to the scheduling result.

In contrast, for example, WLAN is an example of the second radio communication method. An example of the WLAN includes WiFi and Bluetooth (registered trademark). The WiFi is, for example, a WLAN standard authorized by WiFi Alliance, in which IEEE (Institute of Electrical and Electronic Engineers) 802.11 standard is used. The WiFi is not distinguished from the WLAN in some cases. Also, in the Bluetooth, for example, the IEEE 802.15.1 standard is used. The second radio communication method is a radio communication method using carrier sense, for example. The carrier sense is a communication method in which mobile station apparatuses 100-1 to 100-4 and an access point 300-1 detect a frequency use state to prevent the transmission of a plurality of carrier waves (or carriers) with an identical frequency. As examples of the carrier sense, there are CSMA/CA (Carrier Sense Multiple Access/Collision Access), CSMA/CD (Carrier Sense Multiple Access/Collision Detection), etc., for example. The CSMA/CA etc. are methods in which carrier sense and carrier collision avoidance procedures are combined, for example.

As depicted in FIG. 2, the mobile communication system 10 includes mobile station apparatuses (MN [Mobile Node] #1 to MN #4) 100-1 to 100-4, an LTE base station apparatus (eNB [evolved Node B] #1) 200-1 and an access point (AP [Access Point] #1) 300-1. The mobile communication system 10 also includes a communication control apparatus 400 and a content server 500.

Here, the mobile station apparatus 100-1 corresponds to the first mobile station apparatus 100-1 in the first embodiment, for example. Also, the mobile station apparatus 100-2 corresponds to the second mobile station apparatus 100-2 in the first embodiment, for example. Further, the access point 300-1 corresponds to the base station apparatus 300 in the first embodiment, for example. Further, the communication control apparatus 400 corresponds to the communication control apparatus 400 in the first embodiment, for example.

Hereinafter, the mobile station apparatuses 100-1 to 100-4 may be referred to as mobile stations 100-1 to 100-4, the LTE base station apparatus 200-1 may be referred to as an LTE base station 200-1, and the communication control apparatus 400 may be referred to as a control apparatus 400, respectively.

The mobile stations 100-1 to 100-4 are radio communication apparatuses including a feature phone, a smart phone, a tablet terminal, a personal computer and a game apparatus. The mobile stations 100-1 to 100-4 can perform radio communication using two radio communication methods, which are LTE and WLAN. Therefore, the mobile stations 100-1 to 100-4 perform radio communication with the LTE base station 200-1 using the LTE, so that can acquire a content. Also, the mobile stations 100-1 to 100-4 perform radio communication with the access point 300-1 using the WLAN, so that can acquire a content. Additionally, the mobile stations 100-1 to 100-4 can also receive a variety of services such as a speech communication service and a Web reading service.

The LTE base station 200-1 and the access point 300-1 are base station apparatuses which can provide services to the mobile stations 100-1 to 100-4 in each service provision capability range (or a communicable range) of the self-station. The LTE base station 200-1 radio communicates with the mobile stations 100-1 to 100-4 using the LTE radio communication method, and the access point 300-1 radio communicates with the mobile stations 100-1 to 100-4 using the WLAN radio communication method. FIG. 2 illustrates an example in which the LTE base station 200-1 radio communicates with the mobile stations 100-1, 100-2, and the access point 300-1 radio communicates with the mobile stations 100-3, 100-4.

The control apparatus 400, for example, estimates the throughput of each mobile station 100-1 to 100-4 on the basis of information reported from the mobile station 100-1 to 100-4. Then, based on the sum of request throughputs reported from the mobile station 100-1 to 100-4 and the sum of the estimated throughputs, the control apparatus 400 determines whether to allocate the WLAN or the LTE to the mobile station 100-1 to 100-4. The control apparatus 400 notifies the mobile station 100-1 to 100-4 of the result of the allocation. The details of the allocation will be described later in the operation example.

The content server 500 distributes a content to the mobile station 100-1 to 100-4 in response to each distribution request transmitted from the mobile station 100-1 to 100-4, for example. The content server 500 stores each content in a large capacity storage medium such as an HDD (Hard Disk Drive), for example, and reads out data related to the content from the storage medium according to the distribution request, so that can distribute the data.

Here, in the example of the mobile communication system 10 depicted in FIG. 2, an example of providing four mobile stations 100-1 to 100-4 is illustrated. However, it may also be possible to provide one or a plurality of mobile stations. Also, it may also be possible to provide a plurality of sets of LTE base stations 200-1 and access points 300-1.

Hereinafter, each mobile station 100-1 to 100-4, the LTE base station 200-1 and the access point 300-1 may also be referred to as a mobile station 100, an LTE base station 200 and an access point 300, respectively, unless otherwise specified. In the following, each configuration example of the LTE base station 200, the access point 300 and the control apparatus 400 will be described.

<Configuration Example of Mobile Station>

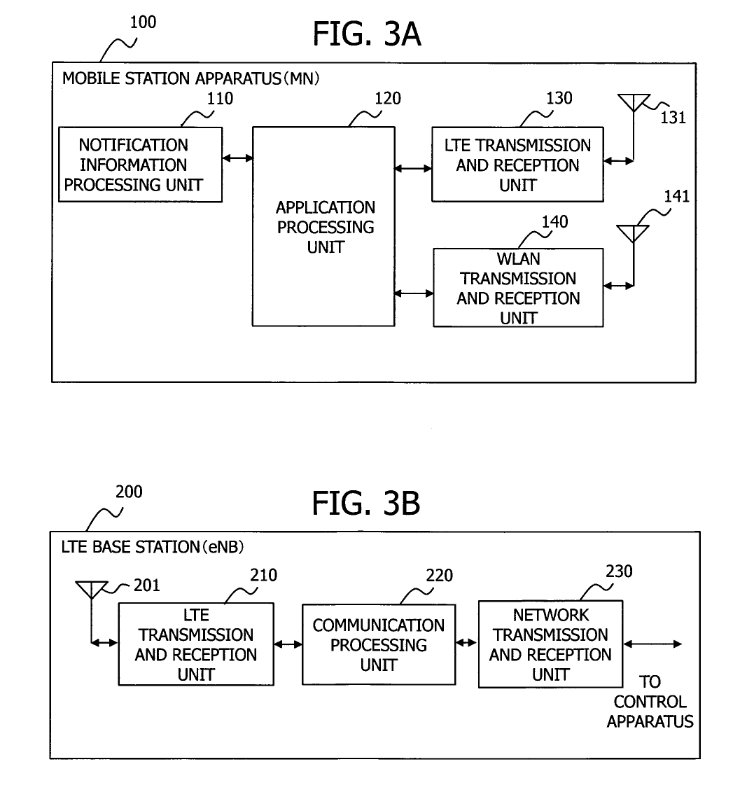

FIG. 3A illustrates a configuration example of the mobile station 100. The mobile station 100 includes a notification information processing unit 110, an application processing unit 120, an LTE transmission and reception unit 130, a WLAN transmission and reception unit 140 and antennas 131, 141.

The notification information processing unit 110, for example, collects a reception level, a request throughput, etc. from the application processing unit 120 to notify the control apparatus 400 of the collected reception level, the request throughput, etc., as notification information.

The application processing unit 120, for example, generates a content distribution request, transmits the generated distribution request to the content server 500, processes a content acquired from the content server 500, and so on. Further, the application processing unit 120, for example, measures the reception level of a radio signal transmitted from the LTE base station 200 and the access point 300. The reception level includes, for example, the reception power of the reception signal and RSSI (Received Signal Strength Indicator). As the reception level, there is a WLAN reception level when the mobile station 100 receives a signal transmitted from the access point 300. Or, as the reception level, there are two reception levels which are the above WLAN reception level and an LTE reception level when the mobile station 100 receives a signal transmitted from the LTE base station 200.

Further, the application processing unit 120 acquires a request throughput on the basis of an application to be executed by the application processing unit 120. The request throughput may include a request throughput according to an application, such as a request throughput associated with SNS (Social Networking Service), a request throughput when viewing a content, and the like. The request throughput, for example, is stored in a memory in the mobile station 100, so that may appropriately be read out when the application processing unit 120 executes the application.

The LTE transmission and reception unit 130 transmits and receives each radio signal between with the LTE base station 200. In this case, the LTE transmission and reception unit 130 performs error correction coding processing and modulation processing according to a scheduling result which is included in a control signal received from the LTE base station 200, and also converts information, a request, etc. received from the application processing unit 120 into a radio signal. The LTE transmission and reception unit 130 outputs the converted radio signal to the antenna 131. Further, the LTE transmission and reception unit 130 performs demodulation processing and error correction decoding processing on a radio signal received from the antenna 131, so as to extract data related to a content destined to the self-station. The LTE transmission and reception unit 130 outputs the extracted data etc. to the application processing unit 120.

The antenna 131 transmits a radio signal received from the LTE transmission and reception unit 130 to the LTE base station 200. The antenna 131 also receives a radio signal transmitted from the LTE base station 200, so as to output the received radio signal to the LTE transmission and reception unit 130.

The WLAN transmission and reception unit 140 transmits and receives each radio signal between with the access point 300, using the WLAN radio communication method. For example, the WLAN transmission and reception unit 140 performs carrier sense such as CSMA/CA, to transmit and receive each radio signal between with the access point 300 through the antenna 141, when no reception signal is detected during a random back-off time. In this case, if a reception signal is detected in the back-off time, the WLAN transmission and reception unit 140 transmits and receives the radio signal after waiting for a predetermined time. At radio signal transmission, the WLAN transmission and reception unit 140, for example, performs error correction coding processing and modulation processing on information, a request, etc. which are received from the application processing unit 120 to convert into a radio signal, and outputs the converted radio signal to the antenna 141. Also, at radio signal reception, the WLAN transmission and reception unit 140, for example, performs demodulation processing and error correction decoding processing on a radio signal received from the antenna 141, and extracts data etc. related to a content from the radio signal, so as to output to the application processing unit 120.

The antenna 141 transmits the radio signal received from the WLAN transmission and reception unit 140 to the access point 300. The antenna 141 also receives a radio signal transmitted from the access point 300, so as to output the received radio signal to the WLAN transmission and reception unit 140.

In the present second embodiment, each mobile station 100-1 to 100-4 receives information related to an allocation result, which indicates whether WLAN is allocated or LTE is allocated, from the control apparatus 400 through the LTE base station 200 or the access point 300. According to the information, the mobile station 100-1 to 100-4 can switch over from LTE to WLAN. Incidentally, 3GPP provides a standard on the switchover from LTE to WLAN for the purpose of offloading (for example, 3GPP TS23.234 V8.0.0).

<Configuration Example of LTE Base Station>

FIG. 3B illustrates a configuration example of the LTE base station 200. The LTE base station 200 includes an antenna 201, an LTE transmission and reception unit 210, a communication processing unit 220 and a network transmission and reception unit 230.

The antenna 201 transmits to a mobile station 100 a radio signal received from the LTE transmission and reception unit 210. Also, the antenna 201 receives a radio signal transmitted from the mobile station 100, to transmit the received radio signal to the LTE transmission and reception unit 210.

The LTE transmission and reception unit 210 performs error correction coding processing, modulation processing, etc. on content data etc. received from the communication processing unit 220, according to a scheduling result, to convert into a radio signal, to output the converted radio signal to the antenna 201. Further, the LTE transmission and reception unit 210 performs demodulation processing and error correction decoding processing on a radio signal according to the scheduling result, and extracts information, a request, etc. from the radio signal, to output the extracted data, the request, etc. to the communication processing unit 220.

The communication processing unit 220, for example, schedules LTE radio communication, to generate a control signal including the scheduling result. The communication processing unit 220 transmits the generated control signal through the LTE transmission and reception unit 210 etc. to the mobile station 100. Also, the communication processing unit 220 outputs the information and the request received from the LTE transmission and reception unit 210, to the network transmission and reception unit 230. Further, the communication processing unit 220 outputs to the LTE transmission and reception unit 210 the content data etc. received from the network transmission and reception unit 230.

The network transmission and reception unit 230, for example, exchanges packet data between with the control apparatus 400. More specifically, the network transmission and reception unit 230, for example, generates packet data, which includes the information, the request, etc. received from the communication processing unit 220, so as to transmit the generated packet data to the control apparatus 400. Also, the network transmission and reception unit 230, for example, receives packet data transmitted from the control apparatus 400, extracts the information, the request, etc. from the received packet data, so as to output the extracted information, the request, etc. to the communication processing unit 220.

<Configuration Example of Access Point>

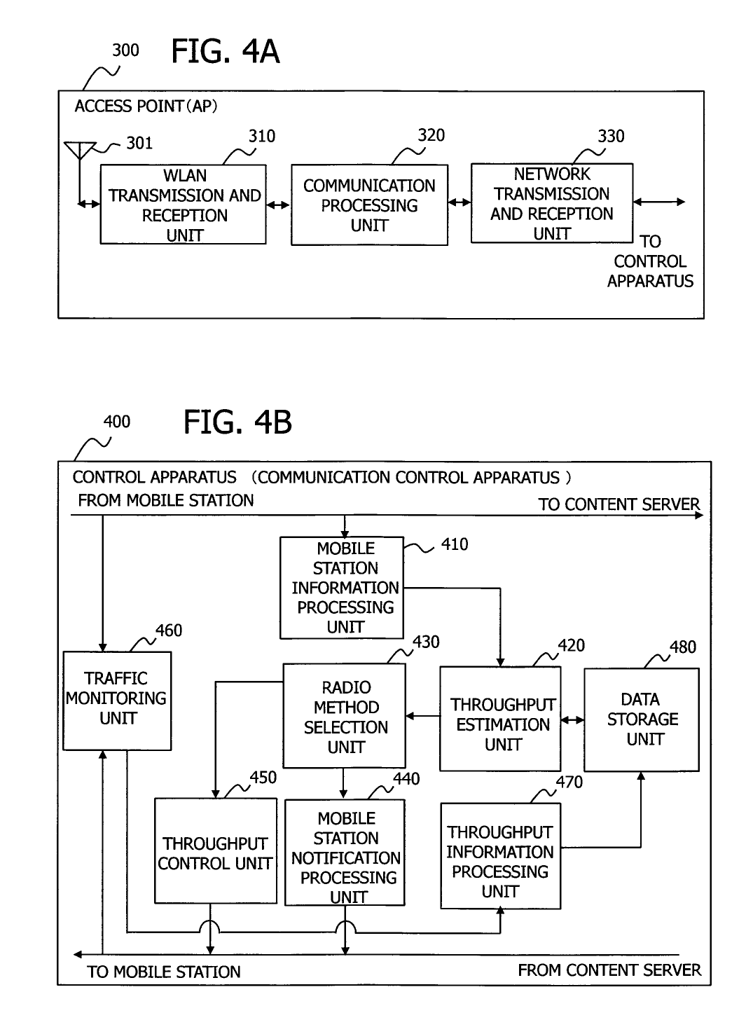

FIG. 4A illustrates a configuration example of the access point 300. The access point 300 includes an antenna 301, a WLAN transmission and reception unit 310, a communication processing unit 320 and a network transmission and reception unit 330.

The antenna 301 transmits a radio signal received from the WLAN transmission and reception unit 310 to the mobile station 100. Also, the antenna 301 receives a radio signal transmitted from the mobile station 100, to output the received radio signal to the WLAN transmission and reception unit 310.

The WLAN transmission and reception unit 310, for example, performs carrier sense such as CSMA/CA, and transmits and receives each radio signal between with the mobile station 100 through the antenna 301, if no reception signal is detected during a random back-off time. In this case, if detecting a reception signal in a back-off time, the WLAN transmission and reception unit 310 performs processing such as transmitting an Ack (acknowledgment) signal to subordinate all mobile stations 100 after the lapse of a predetermined time. At radio signal transmission, the WLAN transmission and reception unit 310, for example, performs modulation processing etc. on content data etc. received from the communication processing unit 320, to convert into a radio signal and output the converted radio signal to the antenna 301. Also, at radio signal reception, the WLAN transmission and reception unit 310, for example, performs demodulation processing etc. on a radio signal received from the antenna 301, to extract information, a request, etc. from the radio signal, to output to the communication processing unit 320.

The communication processing unit 320 outputs, to the network transmission and reception unit 330, the information, the request, etc. received from the WLAN transmission and reception unit 310. Also, the communication processing unit 320 outputs to the WLAN transmission and reception unit 310, the content data etc. received from the network transmission and reception unit 330.

The network transmission and reception unit 330, for example, exchanges packet data between with the control apparatus 400. More specifically, the network transmission and reception unit 330, for example, generates packet data including the information, the request, etc. received from the communication processing unit 320, so as to transmit the generated packet data to the control apparatus 400. Also, the network transmission and reception unit 330, for example, receives packet data transmitted from the control apparatus 400, extracts content data etc. from the received packet data, to output the extracted data etc. to the communication processing unit 320.

<Configuration Example of the Control Apparatus>

FIG. 4B is a diagram illustrating a configuration example of the control apparatus 400. The control apparatus 400 includes a mobile station information processing unit (hereinafter may be referred to as “information processing unit”) 410, a throughput estimation unit 420, a radio method selection unit 430 and a mobile station notification processing unit (hereinafter may be referred to as “notification processing unit”) 440. Further, the control apparatus 400 includes a throughput control unit 450, a traffic monitoring unit 460, a throughput information processing unit 470 and a data storage unit 480.

The information processing unit 410 receives packet data transmitted from the LTE base station 200 and the access point 300, to extract, from the received data, information reported from the mobile station 100. The information includes a reception level, a request throughput, etc., for example. The information processing unit 410 may calculate the sum of each request throughput reported from each mobile station 100, for example. The information processing unit 410 outputs the information collected each mobile station 100 to the throughput estimation unit 420.

The throughput estimation unit 420, for example, estimates the throughput of the mobile station 100 on the basis of a WLAN reception level at the mobile station 100. The throughput estimation unit 420 then calculates the sum of each estimated throughput of the mobile station 100, for example. The calculated throughput, for example, comes to a total throughput to the access point 300. The sum of each estimated throughput may hereafter be referred to as the total throughput, for example. A calculation method etc. of the total throughput will be described in the operation example. The throughput estimation unit 420 outputs the total throughput, the sum of each request throughput received from the information processing unit 410, etc. to the radio method selection unit 430.

The radio method selection unit 430 allocates the WLAN radio communication method to each mobile station 100-1, 100-2, . . . , if the sum of the request throughput of each mobile station 100-1, 100-2, . . . reported from each mobile station 100-1, 100-2, . . . does not exceed the total throughput estimated in the throughput estimation unit 420. On the other hand, for example, if the sum of the request throughput of each mobile station 100-1, 100-2, . . . reported from each mobile station 100-1, 100-2, . . . exceeds the total throughput estimated in the throughput estimation unit 420, the radio method selection unit 430 allocates the LTE radio communication method to each mobile station 100 which corresponds to the excess part. A further description will be given in the operation example on how each radio communication method is selected in the radio method selection unit 430.

The notification processing unit 440, for example, notifies the mobile station 100 of information related to the radio communication method allocated by the radio method selection unit 430.

The throughput control unit 450 receives a request throughput from the radio method selection unit 430, to control the LTE base station 200 and the access point 300 to execute radio communication at a throughput corresponding to the request throughput. For example, the throughput control unit 450 notifies the LTE base station 200 and the access point 300 of information related to the request throughput, to instruct to execute radio communication at the throughput concerned.

The traffic monitoring unit 460 monitors the traffic state of each mobile station 100, to measure whether communication quality is sufficient for the request throughput. For example, the traffic monitoring unit 460 receives a request throughput from the throughput control unit 450, and receives quality information which is measured in the mobile station 100 and transmitted from the mobile station 100, so as to measure the communication quality by comparing the request throughput with the quality information.

The throughput information processing unit 470 determines the measurement result received from the traffic monitoring unit 460, and based on the determination result, adjusts data etc. stored in the data storage unit 480, so as to store the adjusted data etc. into the data storage unit 480. Thereafter, the throughput estimation unit 420 estimates a throughput on the basis of the adjusted data etc.

The data storage unit 480 is, for example, a memory, in which data etc. to be used for the throughput estimation are stored.

<Operation Example>

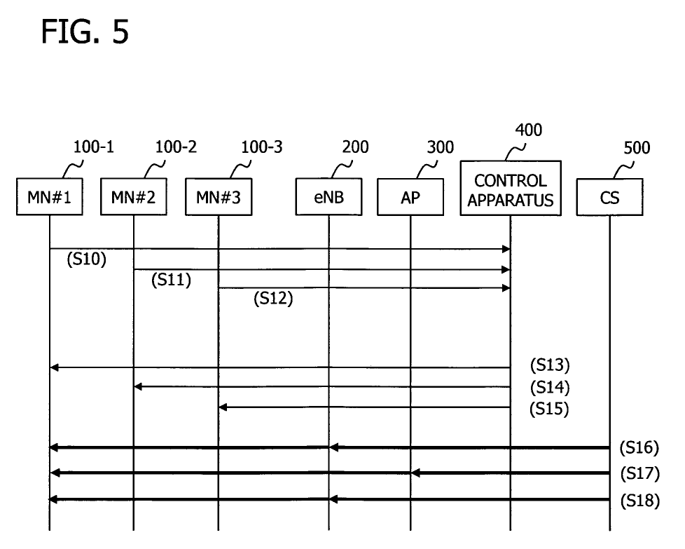

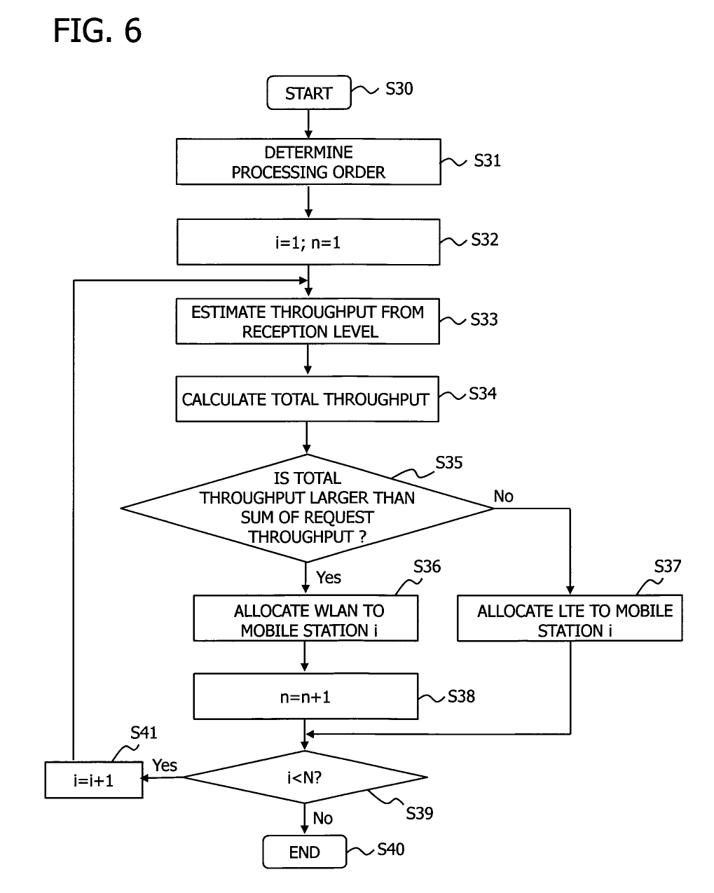

Next, an operation example will be described. FIG. 5 illustrates an overall sequence example of the mobile communication system 10. Also, FIG. 6 is a flowchart illustrating an operation example in the control apparatus 400. First, the overall sequence example will be described, and next, the operation example of the control apparatus 400 will be described.

<Overall Operation Example>

As depicted in FIG. 5, each mobile station 100-1 to 100-3 notifies the control apparatus 400 of information (S10-S13). The information includes the reception level, the request throughput, etc. as described above. Each mobile station 100-1 to 100-3 may perform the notification through either the LTE base station 200, or may perform through the access point 300.

Based on the received information, the control apparatus 400 determines which of WLAN or LTE is to be allocated to each mobile station 100-1 to 100-3, and notifies each mobile station 100-1 to 100-3 of information related to the allocated radio communication method (S13-S15). In the example depicted in FIG. 5, the control apparatus 400 allocates WLAN to the mobile station 100-2, whereas allocates LTE to the mobile stations 100-1, 100-3, and notifies the mobile station 100-2 of information related to WLAN, and notifies the mobile stations 100-1, 100-3 of information related to LTE, respectively.

The mobile station 100-2, for example, executes a switchover from LTE to WLAN, so as to receive a content, transmitted from the content server 500, through the access point 300 (S17). When continuously using WLAN, the mobile station 100-2 may continue using WLAN intact without particularly executing a switchover.

On the other hand, the mobile stations 100-1, 100-3, for example, execute a switchover from WLAN to LTE, to receive a content transmitted from the content server 500 through the LTE base station 200 (S16, S18). When continuously using LTE, the mobile stations 100-1, 100-3 may continue using LTE intact without particularly executing a switchover.

<Operation Example of the Control Apparatus>

As depicted in FIG. 6, on starting processing (S30), the control apparatus 400 determines processing order (S31). For example, the following processing is executed. Namely, the information processing unit 410, when acquiring a plurality of information sets from the plurality of mobile stations 100-1, 100-2, . . . , outputs the acquired information to the throughput estimation unit 420. The throughput estimation unit 420 determines processing order for each mobile station 100-1, 100-2 . . . . The order may be either from the highest reception level of WLAN to the lowest, or from the highest reception level of LTE, or from the highest request throughput. Depending on the order, among the mobile stations 100-1, 100-2 . . . , a mobile station to which WLAN is to be allocated may be changed. The details will be described later. Here, the throughput estimation unit 420 determines the order from the highest LAN reception level to the lowest, like from the mobile station 100-1 to 100-2 to 100-3 . . . .

Next, the control apparatus 400 performs substitution of i=1 and n=1. For example, i indicates processing order and n indicates the number of mobile stations 100 to which WLAN is allocated.

Next, the control apparatus 400 estimates, from the reception level, each throughput of the mobile station 100-1, . . . , 100-i having the processing order up to i (S33). For example, the throughput estimation unit 420 may estimate a throughput on the basis of an association table which indicates relationship between a reception level actually measured in advance and a throughput. Such an association table may be stored in a data storage unit 480. Alternatively, the throughput estimation unit 420 may estimate the throughput of each mobile station 100-1, . . . , 100-i, using the following expression (1).

$$\begin{matrix}[ Expression 1 ] & \\ T = {( {\sum }_{i}^{n} \frac{1}{f ( {L}_{i} )} )}^{- 1} & ( 1 )\end{matrix}$$

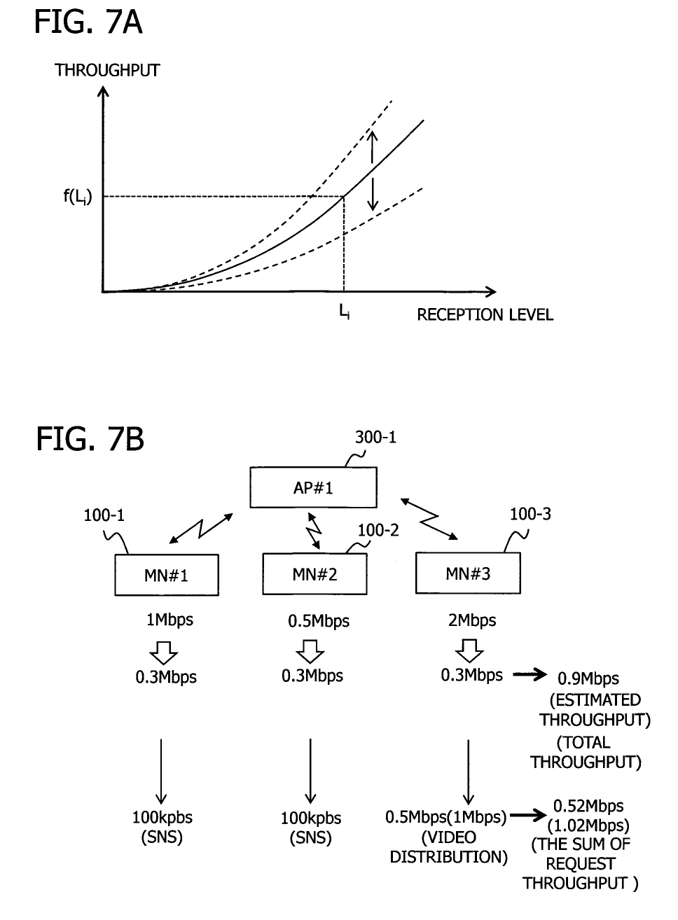

In expression (1), Lᵢ represents the reception level of the i-th mobile station 100-i. Also, f(Lᵢ) represents, for example, the throughput of the individual mobile station 100-i which is estimated from relationship as depicted in FIG. 7A etc.

FIG. 7B illustrates a throughput example etc. in the case of i=3. Expression (1) is explained using an example depicted in FIG. 7B. The throughput estimation unit 420 calculates from FIG. 7A etc. a throughput f(L₁) on the basis of the reception level of the mobile station (MN #1) 100-1, which becomes “1 Mbps”. Similarly, a throughput f(L₂) of the mobile station (MN #2) 100-2 becomes “0.5 Mbps” and a throughput f(L₃) of the mobile station (MN #3) 100-3 becomes “2 Mbps”. In this case, when a throughput T is calculated using expression (1),

T=(1/1+1/0.5+1/2)⁻¹=(7/2)⁻¹=(2/7)≈0.3

is obtained. Therefore, an estimated throughput T for each mobile station 100-1 to 100-3 comes to “0.3 Mbps”, for example.

Expression (1) represents the throughput of data which can be transmitted and received to/from the same access point 300-1 at any mobile station 100 subordinate thereto. For example, if each mobile station 100-1 to 100-3 sets a throughput to be “0.3 Mbps”, the mobile station 100-1 to 100-3 can perform radio communication with the access point 300-1 by WLAN.

It is known that in a radio communication method such as WLAN using carrier sense, each mobile station 100 subordinate to the same access point 300 has nearly the same throughput, and the throughput is determined by a mobile station 100 having the lowest reception level (having the worst communication quality) (for example, refer to “Performance Anomaly of 802.11b”, IEEE INFCOM 2003). Expression (1) is also based on such a concept.

Additionally, in the case of i=1, the throughput becomes T=1 if a throughput “1 Mbps” of the mobile station (MN #1) 100-1 is substituted for expression (1). Thus, also in the case of i=1, the throughput T can be calculated using expression (1).

Referring back to FIG. 6, next, the control apparatus 400 calculates a total throughput (S34). The throughput estimation unit 420 calculates a total throughput T_{AP} using the following expression (2), for example.

[Expression 2]

T_{AP}=nT (2)

In the example of FIG. 7B, the throughput estimation unit 420 totally adds the estimated throughputs “0.3 Mbps” of the mobile stations 100-1 to 100-3, to obtain a total throughput T_{AP}=0.9 Mbps. The total throughput T_{AP} represents a total throughput at the access point 300-1 in the case of radio communication by WLAN with all mobile stations 100-1 to 100-3 subordinate to the access point 300-1, for example.

Additionally, in the case of i=1, the throughput estimation unit 420 obtains a total throughput T_{AP}=T from expression (2), and the throughput estimated in S33 comes to a total throughput T_{AP}.

Next, the control apparatus 400 discriminates whether or not the total throughput T_{AP} is greater than the sum of the request throughputs (S35). For example, the throughput estimation unit 420 performs the discrimination using the following expression (3).

$$\begin{matrix}[ Expression 3 ] & \\ {T}_{AP} > {\sum }_{i}^{R} {R}_{i} & ( 3 )\end{matrix}$$

Here, Rᵢ represents a request throughput when the i-th mobile station 100-i receives a service using LTE or WLAN.

In the example of FIG. 7B, a total throughput T_{AP}=0.9 Mbps, whereas the sum of the request throughputs of the mobile stations 100-1 to 100-3 is “0.52 Mbps”. Therefore, the total throughput T_{AP} is greater than the sum of the request throughputs. In this case, the access point 300-1 has an overall throughput capacity of “0.9 Mbps” when radio communicating with the all subordinate mobile stations 100-1 to 100-3 by WLAN. If the sum of the request throughputs of the mobile stations 100-1 to 100-3 falls within the above-mentioned “0.9 Mbps”, the access point 300-1 can perform WLAN radio communication with a throughput which satisfies each request throughput of the mobile stations 100-1 to 100-3. Accordingly, if the control apparatus 400 allocates WLAN to each mobile station 100-1 to 100-3, the mobile station 100-1 to 100-3 can perform radio communication by WLAN with the request throughput.

Referring back to FIG. 6, therefore, if the total throughput T_{AP} is greater than the sum of the request throughputs (Yes in S35), the control apparatus 400 allocates WLAN to the i-th mobile station 100-i (S36). More specifically, if the sum of the request throughputs is smaller than the total throughput T_{AP} and within the range of the total throughput T_{AP}, the control apparatus 400 allocates WLAN to the i-th mobile station 100-i (S36). Then, the control apparatus 400, for example, increments n (S38), and causes the processing to proceed to S39.

On the other hand, in the example of FIG. 7B, consider a case when the request throughput of the mobile station 100-3 is “1 Mbps”. In this case, a total throughput T_{AP}=0.9 Mbps is smaller than the sum of the request throughputs “1.02 Mbps”. In this case, the access point 300-1 having an overall throughput capacity of “0.9 Mbps” is incapable of radio communicating with all mobile stations 100-1 to 100-3 with a throughput that satisfies the total request throughput “1.02 Mbps” of all mobile stations 100-1 to 100-3. For example, when WLAN is allocated to the mobile stations 100-1 and 100-2, and if the control apparatus 400 further allocates WLAN to the mobile station 100-3, the access point 300 is incapable of radio communicating with all mobile stations 100-1 to 100-3 by WLAN. Therefore, the radio method selection unit 430 allocates LTE to the mobile station 100-3, so that can secure a throughput at the access point 300.

Referring back to FIG. 6, accordingly, when the total throughput T_{AP} is smaller than and including the sum of the request throughputs (No in S35), the control apparatus 400 allocates LTE to the i-th mobile station 100-i (S37). In other words, when the sum of the request throughputs equals to the range of the total throughput T_{AP} or exceeds the above range, the control apparatus 400 allocates LTE to the i-th mobile station 100-i. Then, the control apparatus 400 causes the processing to proceed to S39.

Additionally, in the case of i=1, a total throughput T_{AP} equals the estimated throughput T, as described earlier. Therefore, when the request throughput of the mobile station 100 is smaller than the total throughput (Yes in S35), the control apparatus 400 allocates WLAN to the mobile station 100 (S36). On the other hand, when the request throughput of the mobile station 100 is the total throughput or greater (No in S35), the control apparatus 400 allocates LTE to the mobile station 100.

In S39, the control apparatus 400 discriminates whether or not i is smaller than the total number of the mobile stations, and if i is smaller (Yes in S39), adds “1” to i (S41), and causes the processing to proceed to S33, so as to repeat the above-mentioned processing.

The processing depicted in FIG. 6 may be performed on each constant period basis, or may be performed when the control apparatus 400 receives a connection request from a new mobile station 100. In the former case, the control apparatus 400 may execute the flowchart depicted in FIG. 6 from the first, whereas in the latter case, the control apparatus 400 may update the total number N of the mobile stations so that may execute processing from S33 to S39 for the new mobile station 100.

<Regarding Processing Order>

A description will be given on processing order (for example, S31 in FIG. 6). There are three cases in regard to the processing order. The first is order from the highest reception level of WLAN to the lowest. The second is order from the height request throughput (or request rate). The third is order from the highest reception level of LTE.

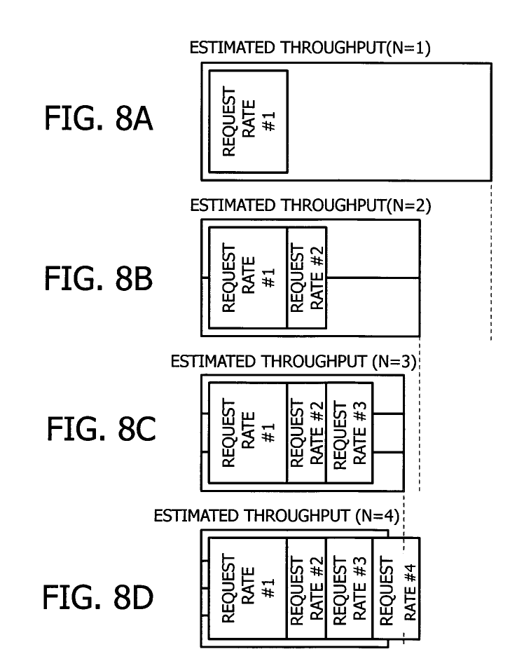

FIGS. 8A-8D are diagrams illustrating an example of the first case (the case when a radio communication method is allocated in order from the highest WLAN reception level to the lowest).

For example, let Lᵢ be the reception level of WLAN at a user i (or mobile station 100-i), and if

L₁>L₂>L₃> . . . >L_{N}

holds, the control apparatus 400 executes allocation processing in order from the mobile station 100-1 to the mobile station 100-2, . . . to 100-N.

As depicted in FIG. 8A, in regard to the mobile station 100-1, the total throughput is an estimated throughput based on the reception level L₁ of the mobile station 100-1 (for example, S34 in FIG. 6). The estimated throughput of the mobile station 100-1 is the largest as compared to other mobile stations, because the reception level L₁ is the largest as compared to the reception levels of other mobile stations 100. Therefore, by the execution of processing in order from the height reception level L to the lowest, it is possible to increase the total throughput (the total sum of the estimated throughputs) as large as possible.

In the example of FIGS. 8A-8D, the sum of the request throughputs of the mobile stations 100-1 to 100-3 fall within the range of the total throughput, and therefore, the control apparatus 400 allocates WLAN to the mobile stations 100-1 to 100-3 (for example, Yes in S35 and S36 in FIG. 6). On the other hand, when the control apparatus 400 executes processing up to the mobile station 100-4, the sum of the request throughputs exceeds the range of the total throughput (for example, No in S35 and S37 in FIG. 6), and therefore, the control apparatus 400 allocates LTE to the mobile station 100-4.

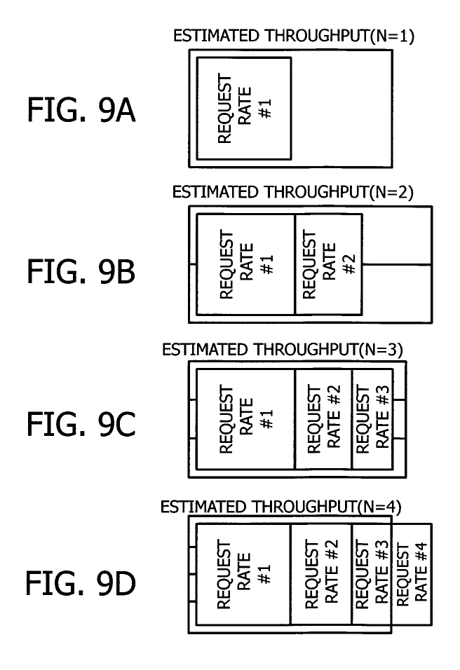

An example depicted in FIGS. 9A-9D illustrates an example of the second case (the case when the processing is executed in order of the request throughput). Let Rᵢ be the request throughput of a user i (mobile station 100-i), and if

R₁>R₂>R₃> . . . >R_{N}

holds, the control apparatus 400 executes allocation processing in order from the mobile station 100-1 to the mobile station 100-2, . . . to 100-N.

By the execution of allocation in order of the request throughput, for example, it is possible to preferentially allocate WLAN to a mobile station 100 having a higher request throughput. Namely, it is possible to preferentially cause a mobile station 100, having a higher request throughput, to be off-loaded to WLAN, which can improve LTE use efficiency also.

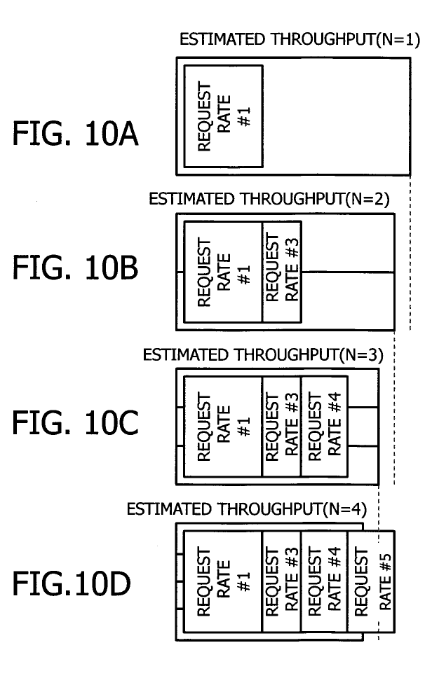

FIGS. 10A-10D illustrate an example of the third case (the case when executing allocation processing in order of the LTE reception level). Typically, in the example, a mobile station 100 having a higher LTE reception level than a threshold is processed in order later than other mobile stations 100. For example, let L′ᵢ be each LTE reception level, and if the level order is

L′₁>L′₃> . . . L′_{N}>L′₂

then, the control apparatus 400 executes processing in order from the mobile station 100-1, to the mobile station 100-3, . . . to the mobile station 100-N and to the mobile station 100-2. In this case, the control apparatus 400 executes allocation processing for the mobile station 100-2, having the highest LTE reception level, in the last place.

In this case, as depicted in FIG. 10D, the possibility of WLAN allocation becomes lower, and the possibility of LTE allocation becomes higher, as the processing order is later. Accordingly, to the mobile station 100-2 having the LTE reception level higher than and including the threshold, the possibility of LTE allocation by the control apparatus 400 increases. Thus, LTE allocation efficiency can be improved as compared to the above-mentioned two cases.

As having been described above, according to the present second embodiment, the communication control apparatus 400 allocates WLAN to each mobile station 100 when the total throughput is greater than the sum of the request throughputs (for example, S35 in FIG. 6). In this case, the sum of the request throughputs falls within the range of the total throughput. In such a case, if the communication control apparatus 400 allocates the first radio communication method to the mobile station 100, each mobile station 100 can radio communicate with the access point 300 by WLAN at each request throughput. Accordingly, the present mobile communication system 10 enables satisfactorily maintaining a connection state to each mobile station if the number of the mobile stations increases.

Further, for example, there is a case that a Mobile Virtual Network Operator pays an LTE usage charge which is higher than a WLAN usage charge. However, according to the present second embodiment, because the control apparatus 400 is configured to allocate WLAN to the mobile station 100, no payment for the LTE usage charge is needed in this case. Therefore, it is also possible to reduce cost in the Mobile Virtual Network Operator.

Further, according to the second embodiment, the communication control apparatus 400 is configured to select the first radio communication method to notify each mobile station 100. Therefore, according to the present second embodiment, radio communication by WLAN is not executed before the selection of the radio communication method, as compared to a case when the communication control apparatus 400 selects WLAN after the mobile station 100 executes radio communication by the first radio communication method. Therefore, according to the present second embodiment, it is possible to reduce a switchover time of the radio communication method.

### Third Embodiment

As described in the second embodiment, the control apparatus 400 is configured to allocate LTE to a mobile station 100 to which WLAN is not allocated (for example, S37 in FIG. 6). There may be a case that the mobile station 100 automatically switches over to LTE without notification of LTE allocation from the control apparatus 400 to the mobile station 100. In this case, it may take a predetermined time for the mobile station 100 to execute the switchover.

Therefore, according to the present third embodiment, the control apparatus 400 notifies the mobile station 100, to which WLAN is not allocated, of the LTE allocation (for example, S13-S15 in FIG. 5). On receiving the notification, the mobile station 100 can immediately connect to the LTE base station 200, so that can early start radio communication.

### Fourth Embodiment

In the second embodiment, the description is given on the example of estimating in the control apparatus 400 the throughput from the reception level (for example, S33 in FIG. 6). Relationship between the reception level and the throughput may be different in between the WLAN standards of IEEE 802.11n and IEEE 802.11ac, for example. Also, the above relationship may be different depending on the number of antennas in the mobile station 100.

Therefore, according to the present fourth embodiment, the mobile station 100 notifies the control apparatus 400 of the WLAN standard used in the mobile station 100, and the type name (or apparatus name), the OS (Operating System) version, the number of antennas, etc. of the mobile station 100, in addition to the reception level and the request throughput. The above information sets may be referred to as radio performance information which represents radio performance at the mobile station 100, for example.

FIG. 7A illustrates an example of relationship between the reception level and the throughput. As depicted with the dotted lines in FIG. 7A, the relationship of correspondence therebetween may be different according to the radio performance. Therefore, the control apparatus 400 may be configured to change the relationship of correspondence on the basis of the radio performance information, so that may estimate a throughput using the relationship of correspondence after the change.

For example, as depicted in FIG. 3, the radio performance information may be collected in the notification information processing unit 110 from the application processing unit 120, or may be stored in the memory of the mobile station 100 so that can appropriately be read out by the notification information processing unit 110. In any case, the notification information processing unit 110 may transmit to the control apparatus 400 the radio performance information in addition to the reception level and the request throughput.

### Fifth Embodiment

In the second embodiment, the description is given on the example of estimating the throughput from the reception level using expression (1). In the present fifth embodiment, a throughput T when the minimum reception level is L among n mobile stations 100-1, . . . , 100-n is calculated by

$$\begin{matrix}[ Expression 4 ] & \\ T = \frac{1}{n} f ( L ) & ( 4 )\end{matrix}$$

Here, f(L) represents a throughput when the number of mobile stations 100 connected to the access point 300 is “1”, similar to the case as described in expression (1), if the reception level is L.

For example, in the example of FIG. 7B, if the reception level L of the mobile station 100-2 is the smallest and the throughput f(L) thereof is 0.5 Mbps, the throughput of the mobile station 100-1 and the throughput of the mobile station 100-3 become “0.5 Mbps” to follow the lowest throughput. Thus, from expression (4), a throughput T=1/3(0.5+0.5+0.5)=0.5 Mbps is obtained.

In the present fifth embodiment, the control apparatus 400 can estimate the throughput more easily using expression (4) than using expression (1).

### Sixth Embodiment

The present sixth embodiment is an example of executing, in a throughput control unit 450, throughput control according to a request throughput.

When the mobile station 100 transmits a request throughput, there may be an actual case of acquiring a content and using an application such as SNS, with the request throughput or greater, for example.

Therefore, according to the present sixth embodiment, the traffic monitoring unit 460 monitors the traffic of the mobile station 100, and according to the measurement result thereof, updates information stored in the data storage unit 480. The information is utilized when the throughput estimation unit 420 performs throughput estimation, for example. This enables throughput estimation based on an actual traffic state, so that can improve accuracy in the throughput estimation.

### Seventh Embodiment

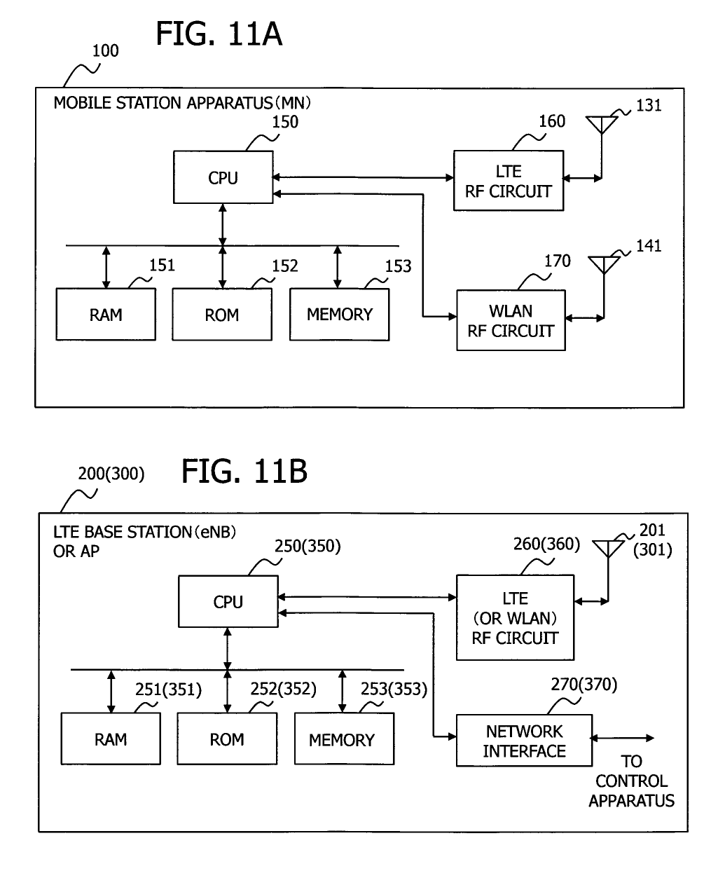

FIG. 11A illustrates a hardware configuration example of the mobile station 100. The mobile station 100 includes a CPU (Central Processing Unit) 150, a RAM (Random Access Memory) 151, a ROM (Read Only Memory) 152, a memory 153, an LTE RF (Radio Frequency) circuit 160, a WLAN RF circuit 170 and antennas 131, 141.

The CPU 150, for example, reads out a program stored in the ROM 152 to load on the RAM 151 and execute the loaded program, so that can achieve functions of the notification information processing unit 110 and the application processing unit 120 in the second embodiment. The CPU 150 corresponds to the notification information processing unit 110 and the application processing unit 120, for example.

Also, the LTE RF circuit 160 corresponds to the LTE transmission and reception unit 130 in the second embodiment, for example. Further, the WLAN RF circuit 170 corresponds to the WLAN transmission and reception unit 140 in the second embodiment, for example.

FIG. 11B illustrates a hardware configuration example of the LTE base station 200. The LTE base station 200 includes a CPU 250, a RAM 251, a ROM 252, a memory 253, an LTE RF circuit 260, a network interface 270 and an antenna 201.

The CPU 250, for example, reads out a program stored in the ROM 252 to load on the RAM 251 and execute the loaded program, so that can achieve a function of the communication processing unit 220 in the second embodiment. The CPU 250 corresponds to the communication processing unit 220, for example. Also, the LTE RF circuit 260 corresponds to the LTE transmission and reception unit 210 in the second embodiment, for example. Further, the network interface 270 corresponds to the network transmission and reception unit 230 in the second embodiment, for example.

FIG. 11B also represents a hardware configuration example of the access point 300. The access point 300 includes a CPU 350, a RAM 351, a ROM 352, a memory 353, a WLAN RF circuit 360, a network interface 370 and an antenna 301.

The CPU 350, for example, reads out a program stored in the ROM 352 to load on the RAM 351 and execute the loaded program, so that can achieve a function of the communication processing unit 320 in the second embodiment. The CPU 350 corresponds to the communication processing unit 320, for example. Also, the WLAN RF circuit 360 corresponds to the WLAN transmission and reception unit 310 in the second embodiment, for example. Further, the network interface 370 corresponds to the network transmission and reception unit 330 in the second embodiment, for example.

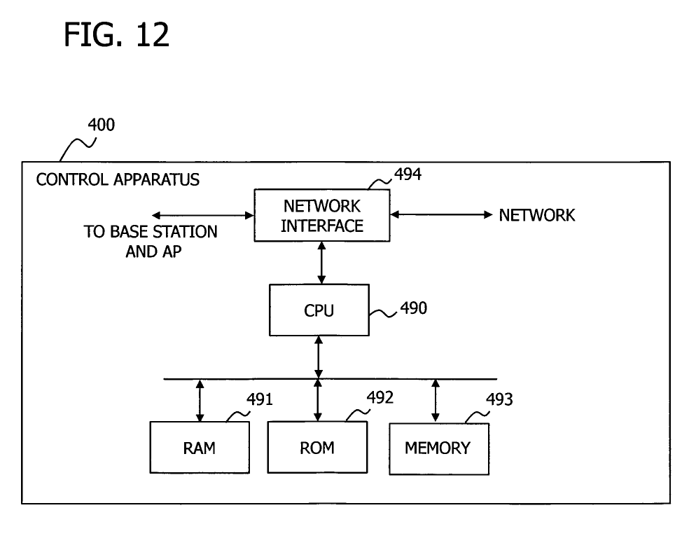

FIG. 12 illustrates a hardware configuration example of the control apparatus 400. The control apparatus 400 includes a CPU 490, a RAM 491, a ROM 492, a memory 493 and a network interface 494.

The CPU 490, for example, reads out a program stored in the ROM 492 to load on the RAM 491 and execute the loaded program, so that can achieve functions of the throughput estimation unit 420, the radio method selection unit 430 and the notification processing unit 440 in the second embodiment. The CPU 490 can also achieve functions of the throughput control unit 450, the traffic monitoring unit 460 and the throughput information processing unit 470 in the second embodiment, for example. The CPU 490 corresponds to the throughput estimation unit 420, the radio method selection unit 430, the notification processing unit 440, the throughput control unit 450, the traffic monitoring unit 460 and the throughput information processing unit 470, for example.

Also, the memory 493 corresponds to the data storage unit 480 in the second embodiment, for example. Further, the network interface 494 corresponds to the information processing unit 410 in the second embodiment, for example.

Each CPU 150, 250, 350, 490 may be a controller, or a control unit, composed of an MPU (Micro Processing Unit), a DSP (Digital Signal Processor), an FPGA (Field Programmable Gate Array) or the like.

### Eighth Embodiment

In the second to the seventh embodiments, the control apparatus 400 performs LTE allocation when the total throughput is greater than the sum of the request throughputs (No in S35 of FIG. 6) (S37). However, for example, when the number of mobile stations 100 to which LTE is allocated is a predetermined number or greater, there may be a case that the radio quality of each mobile station 100 with respect to the LTE base station 200 is deteriorated to or below predetermined quality.

Therefore, according to the present eighth embodiment, the control apparatus 400 is configured to perform evaluation using an evaluation formula, for both cases when a mobile station 100, to which LTE is allocated, performs radio communication by WLAN and when the mobile station 100 performs radio communication by LTE intact. Then, if the control apparatus 400 obtains an improved evaluation result when radio communicating by WLAN than when radio communicating by LTE intact, the control apparatus 400 changes a radio communication method for the mobile station 100 from LTE to WLAN.

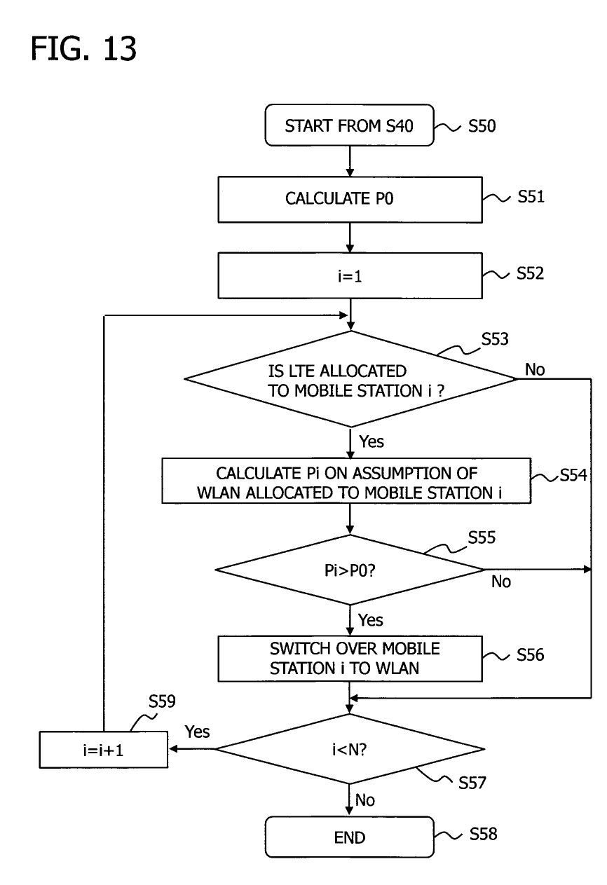

FIG. 13 is a flowchart illustrating an operation example according to the eighth embodiment. The control apparatus 400 starts the present operation after allocating a radio communication method to each mobile station 100 (that is, after the completion of S40 in FIG. 6) (S50).

Next, the control apparatus 400 calculates an evaluation value P0 with respect to the allocation of the radio communication method to each mobile station 100, using an evaluation formula (S51). The following is used as the evaluation formula, for example.

$$\begin{matrix}[ Expression 5 ] & \\ P = {\prod }_{k = 1}^{K} min ( \frac{{T}_{k}}{{Q}_{k}} , 1 ) & ( 5 )\end{matrix}$$

In expression (5), for example, Qₖ represents a request throughput of a mobile station 100ₖ, and Tₖ represents an actual throughput according to a radio communication method allocated to the mobile station 100ₖ, respectively.

For example, expression (5) represents an evaluation value calculated based on the comparison result of an actual throughput Tₖ with the request throughput Qₖ (or the ratio of the actual throughput Tₖ to the request throughput Qₖ) for each mobile station 100ₖ. In this case, from expression (5), P=1 is obtained if the request throughput Qₖ is the actual throughput Tₖ or greater, whereas 0<P<1 is obtained if the request throughput Qₖ is smaller than the actual throughput Tₖ. Therefore, for all mobile stations 100, P=1 is obtained if the request throughput Qₖ is the actual throughput Tₖ or greater, whereas the evaluation value P takes a value smaller than 1 if the request throughput Qₖ of at least one among all mobile stations 100 is smaller than the actual throughput Tₖ.

Here, the actual throughput represents a “throughput obtained by measurement” or an “estimated throughput” estimated based on the reception level and the reception quality, etc.

The “throughput obtained by measurement” is, for example, the number of packets transmitted per unit time from the LTE base station 200, or the access point 300, to the mobile station 100, or the number of Ack signals and Nack (negative acknowledgement) signals received from the mobile station 100 in response to the number of the transmitted packets, when the LTE base station 200 or the access point 300 performs radio communication with the mobile station 100. For example, the communication processing unit 220 in the LTE base station 200 or the communication processing unit 320 in the access point 300 counts the number of the transmitted packets or the number of the received Ack and Nack signals, to transmit to the control apparatus 400 the above count result by including in the mobile station information. Then, the throughput estimation unit 420 in the control apparatus 400 may calculate the number of the packets etc. per unit time, so as to calculate the “throughput obtained by measurement”.

The “estimated throughput” represents, for example, a throughput estimated based on the level and the reception quality received from the mobile station 100, when the LTE base station 200 or the access point 300 performs radio communication with the mobile station 100. For example, similar to the second embodiment, the throughput estimation unit 420 may calculate the “estimated throughput” using expression (1), on the basis of the reception level of the mobile station 100 (for example, FIG. 7A). Alternatively, the throughput estimation unit 420 may calculate the “estimated throughput” from the relationship between the number of users and the throughput.

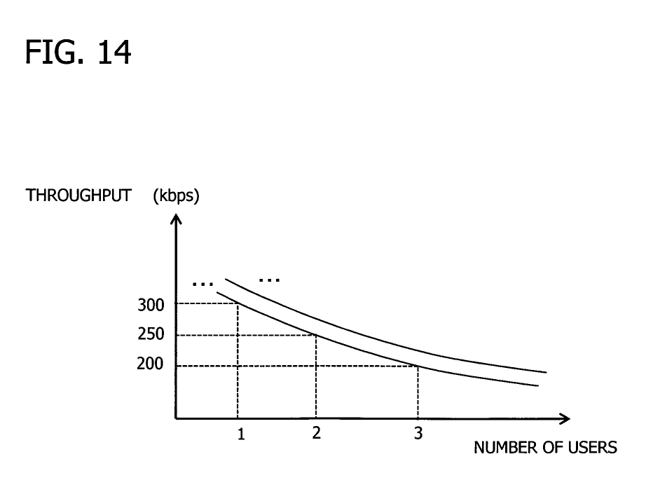

FIG. 14 illustrates an example of relationship between the number of users and the throughput in WLAN. FIG. 14 represents that the throughput of each user to one access point 300 gradually decreases as the number of the users (or the number of the mobile stations) increases. For example, the following is a case. Namely, when the number of the users (or the number of the mobile stations) is “1”, and the estimated throughput of the user is “300” (kbps), the throughput of the user concerned is “300” (kbps). When the number of the users is “2” and each estimated throughput is “300”, then the throughput of each user comes to “250”, and when the number of the users is “3” and the estimated throughput is “300” each, then the throughput of each user comes to “200”. The above throughput of each user becomes the “estimated throughput”. The throughput estimation unit 420 may retain a table indicative of such relationship in a memory, for example, so that may calculate the “estimated throughput” from the relationship between the number of the users and the throughput of each user.

As such, the actual throughput represents a throughput when, for example, the mobile station 100 actually performs radio communication with the LTE base station 200 or the access point 300.

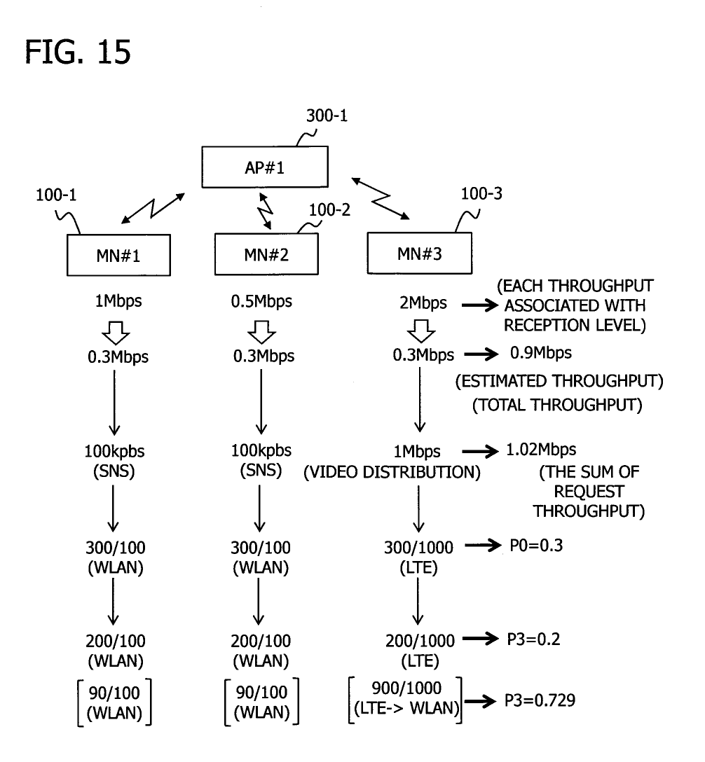

A typical example of the calculation of an evaluation value P0 will be described below. FIG. 15 illustrates each example of the evaluation values. In the example depicted in FIG. 15, the total throughput and the request throughput are the same as in the second embodiment (FIG. 7B). Namely, each request throughput of the mobile stations 100-1, 100-2 is 100 kbps, the request throughput of the mobile stations 100-3 is 1 M (=1,000 k) bps, whereas the estimated throughput is 300 kbps each. For example, the throughput estimation unit 420 calculates expression (5) on assumption that the estimated throughput equals the actual throughput. As a result, the throughput estimation unit 420 obtains the following:

P0=min(300/100, 1)×min(300/100, 1)×min(300/1000, 1)=1×1×0.3=0.3

The above P0=0.3 comes to an evaluation value when WLAN or LTE is allocated to each mobile station on the basis of FIG. 6. The evaluation value P0 represents a value calculated based on the comparison result of the estimated throughput with the request throughput (or the ratio of the estimated throughput to the request throughput) for each mobile station 100, when each radio communication method is allocated to each mobile station 100 in the second embodiment, for example. The throughput estimation unit 420 outputs the evaluation value P0 to the radio method selection unit 430.

Here, for example, expression (5) is stored in the memory of the control apparatus 400. The throughput estimation unit 420, after appropriately reads out from the memory at processing, substitutes the request throughput Qₖ and the actual throughput Tₖ into expression (5) to obtain the evaluation value P.

Referring back to FIG. 13, next, the control apparatus 400 adds “1” to i. Here, i represents the number of the mobile station 100. In the example of FIG. 15, i=1 represents the mobile station 100-1.

Referring back to FIG. 13, next, the control apparatus 400 discriminates whether or not LTE is allocated to a mobile station i (S53). For example, the radio method selection unit 430 stores, in the memory etc., flag information indicative of either WLAN or LTE allocated to each mobile station 100, so that may perform the above discrimination based on the flag information.

When LTE is not allocated to the mobile station i (No is S53), the control apparatus 400 discriminates whether or not i is smaller than the total number N of mobile stations (S57). Then, if i is smaller than the total number N of the mobile stations (Yes in S57), the control apparatus 400 adds “1” to i (S59), and proceeds to S53. For example, in the example of FIG. 15, because LTE is not allocated to the mobile station 100-1, and i=1 is smaller than the total number N (for example, N=3) of the mobile stations, the radio method selection unit 430 adds “1” to i, to perform the processing of S53 and thereafter for the mobile station 100-2. Also, because LTE is not allocated to the mobile station 100-2, the radio method selection unit 430 adds “1” to i, to perform the processing of S53 and thereafter for the mobile station 100-3.

On the other hand, when LTE is allocated to the mobile station i (Yes in S53), the control apparatus 400 calculates Pi on the assumption that WLAN is allocated to the mobile station i (S54). For example, the throughput estimation unit 420 calculates P3 using expression (5) on the assumption that WLAN is allocated to the mobile station 100-3. For example, the throughput estimation unit 420 calculates “estimated throughputs” T₁-T₃ using the example of relationship depicted in FIG. 14. For example, the following calculation is obtained. Namely, because each “estimated throughput” of the mobile stations 100-1 to 100-3 is 300 kbps, each “actual throughput” T₁-T₃ of the mobile stations 100-1 to 100-3 comes to “200” (kbps) if WLAN is allocated to the mobile station 100-3. Accordingly, by the calculation of an evaluation value P3 by the throughput estimation unit 420 using expression (5),

P3=min(200/100, 1)×min(200/100, 1)×min(200/1000, 1)=1×1×0.2=0.2

is obtained. Here, the evaluation value P3 is an evaluation value of the comparison result of the actual throughput with the request throughput (or the ratio of the actual throughput to the request throughput) of each mobile station 100-1 to 100-3, for the mobile station 100-3 to which LTE is allocated in the second embodiment, if WLAN is allocated thereto. The throughput estimation unit 420 outputs the evaluation value P3 to the radio method selection unit 430.

Referring back to FIG. 13, next, the control apparatus 400 discriminates whether or not Pi>P0 is satisfied (S35). If Pi>P0 (Yes in S55), the control apparatus 400 determines to change (or switch over) the radio communication method of the mobile station i from LTE to WLAN (S56). Then, the control apparatus 400 discriminates whether or not processing is completed for all mobile stations 100 (S57).

On the other hand, if Pi>P0 is not satisfied (No in S55), the control apparatus 400 leaves the radio communication method of the mobile station i intact without a change to WLAN, so that the processing proceeds to S57.

In the example of FIG. 15, P3=0.2<P0=0.3 holds. In this case, as compared to a case when WLAN is allocated to the mobile station 100-3, a greater evaluation value is obtained if LTE is left allocated to the mobile station 100-3 without a change. Therefore, the radio method selection unit 430 leaves the allocation of LTE to the mobile station 100-3 intact without changing the allocation thereto (No in S55). On the other hand, in the following, consider a case when “90” is obtained as each “actual throughput” T₁, T₂ of each mobile station 100-1, 100-2, and “900” is obtained as an “actual throughput” T₃ of the mobile station 100-3, for example. In this case, as depicted in FIG. 15, the throughput estimation unit 420 obtains

P3=min(90/100, 1)×min(90/100, 1)×min(900/1000, 1)=0.9×0.9×0.9=0.729

In this case, because of P3>P0, a greater evaluation value is obtained if WLAN is allocated to the mobile station 100-2 as compared to a case when LTE is left allocated to the mobile station 100-2. Accordingly, the radio method selection unit 430 changes the radio communication method of the mobile station 100-3 from LTE to WLAN. As such, based on the evaluation values P0, P3 obtained from the throughput estimation unit 420, the radio method selection unit 430 determines whether to change the mobile station 100, to which LTE has been allocated, to WLAN.

Thus, the control apparatus 400 compares an actual throughput Tₖ relative to a request throughput Qₖ between the cases when WLAN is allocated to the mobile station 100 to which LTE has been allocated (Pi) and when LTE is allocated thereto (P0), and based on the evaluation value, determines whether or not to change the allocation.

This enables, for example, the control apparatus 400 to grasp the detailed degree of satisfaction of the actual throughput Tₖ in comparison with the request throughput Qₖ before and after the change of allocation, to obtain the evaluation value. Accordingly, for example, it is possible to avoid a case when the transmission quality of a user (or mobile station 100) to which LTE is allocated deteriorates to a predetermined quality or lower, so that can maintain the transmission quality of a user, to which LTE is allocated, to be higher than the predetermined quality, as well as in a user to which WLAN is allocated.

### Ninth Embodiment

In the second embodiment, in regard to the processing order (S31 in FIG. 6), the description has been made on the example in which allocation processing is performed in order of the LTE reception levels, for example. Typically, as depicted in FIGS. 10A-10D, the description has been given on the example in which the processing order is determined in such a manner that a mobile station 100 having a higher LTE reception level than the threshold is processed later than other mobile stations 100.

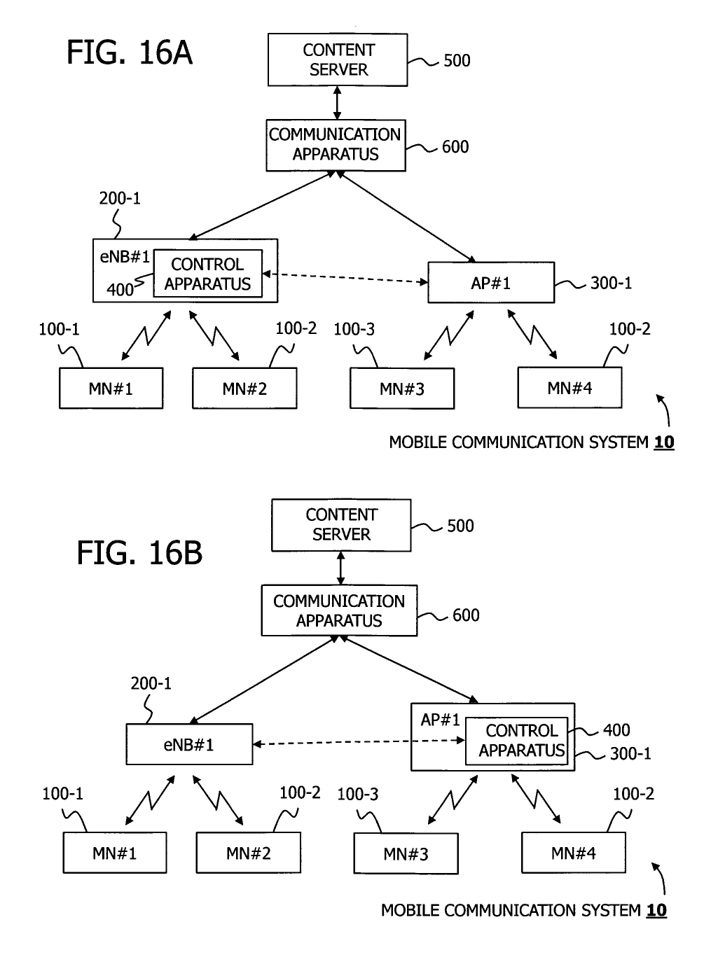

For example, the control apparatus 400 may perform allocation in order from the lowest LTE reception level to the highest. This enables the radio method selection unit 430 of the control apparatus 400 to allocate WLAN to a mobile station 100 having an LTE reception level lower than a predetermined level, and to allocate LTE to a mobile station 100 having an LTE reception level higher than the predetermined level. As the processing thereof, in S31 of FIG. 16, the processing order is changed in order from a mobile station 100 having the lowest LTE reception level to the highest. According to the above order, the allocation method, including the throughput estimation (S33) and the total throughput calculation (S34) as described in the second embodiment, is applied.

### Tenth Embodiment

In the second embodiment to the ninth embodiment, it is described that, for example, the control apparatus 400 is a different apparatus from the LTE base station 200 or the access point 300. For example, it may also be possible that the control apparatus 400 is included in the LTE base station 200 or the access point 300.

FIG. 16A illustrates a configuration example of a mobile communication system 10 in which a control apparatus 400 is included in an LTE base station 200-1. Also, FIG. 16B illustrates a configuration example of a mobile communication system 10 in which a control apparatus 400 is included in an access point 300-1.

In the example depicted in FIG. 16A, the control apparatus 400 performs communication with the access point 300-1 through a communication apparatus 600, so as to receive mobile station information and exchange packet data. As depicted with the dotted line, the control apparatus 400 may directly communicate with the access point 300 without the intermediary of the communication apparatus 600, so that may exchange information and data. In this case, the communication apparatus 600 may be deleted.

Also, in the example depicted in FIG. 16B, the control apparatus 400 performs communication with an LTE base station 200-1 through a communication apparatus 600. However, the control apparatus 400 may directly communicate with the LTE base station 200-1 without the intermediary of the communication apparatus 600. In the latter case, the communication apparatus 600 may be deleted.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A communication control apparatus comprising:
a throughput estimation unit configured to estimate a first throughput in case that a first mobile apparatus performs radio communication with a base station apparatus based on first information notified from the first mobile communication apparatus;
a radio method selection unit configured to allocate to the first mobile station apparatus a first radio communication method performing radio communication with the base station apparatus by using a carrier sense method, when a first request throughput notified from the first mobile station apparatus and requested by the first mobile station apparatus is smaller than the estimated first throughput; and
a notification processing unit configured to notify information relating to the allocated first radio communication method to the first mobile station apparatus.

2. The communication control apparatus according to claim 1, wherein
the radio method selection unit is configured to allocate to the first mobile station apparatus a second radio communication method performing radio communication by using a scheduling method, when the first request throughput is equal to or higher than the estimated first throughput.

3. The communication control apparatus according to claim 2, wherein
the notification processing unit is configured to notify information relating to the allocated second radio communication method to the first mobile station apparatus.

4. The communication control apparatus according to claim 1, wherein
the throughput estimation unit is configured to estimate a second throughput of the second mobile station apparatus based on second information notified from a second mobile station apparatus, and
the radio method selection unit is configured to allocate the first radio communication method to the first and second mobile station apparatuses, when a sum of the first request throughput and a second request throughput notified from the second mobile station apparatus and requested by the second mobile station apparatus is smaller than a sum of the estimated first throughput and the estimated second request throughput.

5. The communication control apparatus according to claim 4, wherein
the notification processing unit is configured to notify information relating to the allocated first radio communication method to the second mobile station apparatus.

6. The communication control apparatus according to claim 4, wherein
the radio method selection unit is configured to allocate to the second mobile station apparatus a second radio communication method performing radio communication by using a scheduling method, when the sum of the first request throughput and the second request throughput is equal to or higher than the sum of the estimated first throughput and the estimated second throughput.

7. The communication control apparatus according to claim 6, wherein
the notification processing unit is configured to notify information relating to the allocated second radio communication method to the second mobile station apparatus.

8. The communication control apparatus according to claim 4, wherein
the throughput estimation unit configured to estimate the first throughput and the second throughput in order from the first mobile station apparatus notified the first information indicated as a first reception level that is higher than a second reception level indicated by the second information, when the first and second information indicate the first and second reception revels in case that the first and second mobile station apparatuses perform radio communication by using the first radio communication method, respectively, and
the radio method selection unit is configured to allocate the first radio communication method to the first mobile station apparatus when the first request throughput is smaller than the estimated first throughput according to the order, and allocate the first radio communication method to the first and second mobile station apparatuses when the sum of the first request throughput and the second request throughput is smaller than the sum of the estimated first throughput and the estimated second throughput.

9. The communication control apparatus according to claim 4, wherein
the throughput estimation unit is configured to estimate the first throughput and the second throughput in order from the first mobile station apparatus notified the first request throughput that a request throughput is high, when the first and second information indicate the first and second request throughputs respectively, and
the radio method selection unit is configured to allocate the first radio communication method to the first mobile station apparatus when the first request throughput is smaller than the estimated first throughput according to the order, and allocate the first radio communication method to the first and second mobile station apparatuses when the sum of the first request throughput and the second request throughput is smaller than the sum of the estimated first throughput and the estimated second throughput.

10. The communication control apparatus according to claim 4, wherein
the throughput estimation unit is configured to estimate the second throughput of the second mobile station apparatus notified the second information indicated as a second reception revel that is higher than a first reception level indicated by the first information, after estimating the first throughput, when the first and second information indicate the first and second reception levels respectively in case that the first and second mobile station apparatuses performs radio communication by using a second radio communication method performing radio communication by using a scheduling method, and
the radio method selection unit is configured to allocate the first radio communication method to the first mobile station apparatus when the first request throughput is smaller than the estimated first throughput, and allocate the first radio communication method to the first and second mobile station apparatuses when the sum of the first request throughput and the second request throughput is smaller than the sum of the estimated first throughput and the estimated second throughput.

11. The communication control apparatus according to claim 2, wherein
the throughput estimation unit is configured to estimate a third throughput in case that the first mobile station apparatus allocated the second radio communication method performs radio communication with the base station apparatus by using the first radio communication method, calculate a first evaluation value based on a first comparison result of the estimated first throughput with the first request throughput, and calculate a second evaluation value based on a second comparison result of the estimated third throughput with the first request throughput, and
the radio method selection unit is configured to determine whether or not the radio method selection unit is configure to change a radio communication method of the first mobile station apparatus from the second radio communication method to the first radio communication method based on the first evaluation value and the second evaluation value.

12. The communication control apparatus according to claim 6, wherein
the throughput estimation unit is configured to estimate a fourth throughput of the first mobile station apparatus and a fifth throughput of the second mobile station apparatus in case that the second mobile station apparatus allocated the second radio communication method performs radio communication with the base station apparatus by using the first radio communication method, calculate a third evaluation value based on a first comparison result of the estimated first throughput with the first request throughput and a third comparison result of the estimated second throughput with the second request throughput, and calculate a fourth evaluation value based on a fourth comparison result of the estimated fourth throughput with the first request throughput and a fifth comparison result of the estimated fifth throughput with the second request throughput, and
the radio method selection unit is configured to determine whether or not the radio method selection unit is configured to change a radio communication method of the second mobile station apparatus from the second radio communication method to the first radio communication method based on the third evaluation value and the fourth evaluation value.

13. The communication control apparatus according to claim 4, wherein
the throughput estimation unit is configure to estimate the first throughput of the first mobile station apparatus that a reception revel is low, and estimate the second throughput of the second mobile station apparatus, when the first and second information indicates reception levels in case that the first and second mobile station apparatuses perform radio communication by using a second radio communication method performing radio communication by a scheduling method, and
the radio method selection unit is configured to allocate the first and second radio communication methods to the first and second mobile station apparatuses in order from the first mobile station apparatus.

14. A mobile communication system comprising:
a first mobile station apparatus;
a base station apparatus; and
a communication control apparatus, wherein
the communication control apparatus including:
a throughput estimation unit configured to estimate a first throughput in case that the first mobile apparatus performs radio communication with the base station apparatus, based on first information notified from the first mobile communication apparatus;
a radio method selection unit configured to allocate to the first mobile station apparatus a first radio communication method performing radio communication with the base station apparatus by using a carrier sense method, when a first request throughput notified from the first mobile station apparatus and requested by the first mobile station apparatus is smaller than the estimated first throughput; and
a notification processing unit configured to notify information relating to the allocated first radio communication method to the first mobile station apparatus.

15. A communication control method in a communication control apparatus including a throughput estimation unit, a radio method selection unit, and a notification processing unit, the method comprising:
estimating a first throughput in case that a first mobile apparatus performs radio communication with a base station apparatus, based on first information notified from the first mobile communication apparatus, by the throughput estimation unit;
allocating to the first mobile station apparatus a first radio communication method performing radio communication with the base station apparatus by using a carrier sense method, when a first request throughput notified from the first mobile station apparatus and requested by the first mobile station apparatus is smaller than the estimated first throughput, by the radio method selection unit; and
notifying information relating to the allocated first radio communication method to the first mobile station apparatus, by the notification processing unit.
